(19) United States
(12) Patent Application Publication
(10) Pub. No.: US 2017/0297894 A1
(43) Pub. Date: Oct. 19, 2017

(54) SAFETY STIRRUP FOR HORSE RIDING

(71) Applicant: LOOK CYCLE INTERNATIONAL, Nevers (FR)

(72) Inventor: Thierry FOURNIER, Saint-Paul (FR)

(21) Appl. No.: 15/488,030

(22) Filed: Apr. 14, 2017

(30) Foreign Application Priority Data
Apr. 19, 2016 (FR) 16 53433

(51) Int. Cl. B68C 1/18; B68C 3/02; B68C 3/00

(52) U.S. Cl. CPC B68C 1/18; B68C 3/02; B68C 2003/0066

(57) ABSTRACT

A safety stirrup for horse riding has a buckle (1) designed to be attached to a stirrup leather, a stirrup having an overall arch shape in which a rider inserts a foot in an insertion direction substantially perpendicular to the plane containing the arch, with a tread on the lower portion onto which a rider can place his foot, and at least one lateral branch (21, 22) linking said tread to a head (23) of the stirrup, and a device for attaching the head (23) of the stirrup to the buckle (1) that is designed to enable the stirrup to detach completely from the buckle (1) in the event of a fall. The attachment device includes a mechanism (3) for clipping the stirrup to the buckle (1) including at least one elastic element (31) designed to cooperate with at least one relief (13, 14) provided on a corresponding surface to prevent the stirrup from unclipping from the buckle (1), and a lower end of the buckle (1) and the head (23) of the stirrup cooperating via curved sliding surfaces (11a, 12a, 27) to enable, before unclipping and/or complete detachment of the stirrup and of the buckle (1), a relative rotation of the stirrup and of the buckle (1) in said insertion direction of a foot of the rider in the stirrup.

### RELATED APPLICATION

This application claims the benefit of French Patent Application No. FR 16 53433, filed on Apr. 19, 2016, the entirety of which is incorporated by reference.

### BACKGROUND

### Field of the Invention

The present invention relates to a safety stirrup for horse-riding designed to improve safety when practising horse riding by eliminating the risk of the rider getting his foot caught in the stirrup after falling from the horse and being dragged by the horse, which has continued running.

### Description of Related Art

Different types of safety stirrup have already been proposed, and can be categorized into several broad families:

A first family includes single-branch stirrups, which are open at the top and have a shorter outer branch that is made of a soft material designed to bend in the event of a fall to release the foot. Document FR 2946331 A1 notably describes a horse-riding stirrup of this type with a single connecting half-arch between a tread of the stirrup and an eyelet for mounting the stirrup to a stirrup leather, and a soft outer branch rigidly connected to one end of the tread and free at the other end located closer to the eyelet.

A second family includes stirrups in which the tread is articulated such as to release the foot in the event of a fall. Document TWM 252706 U describes an example of a safety stirrup of this type.

A third family includes stirrups in which a pivoting foot support is mounted between two branches of a mounting element such that same can completely disengage in the event of a fall, thereby releasing the foot. An example of a stirrup of this type is described notably in document EP 1395515 B1.

Other stirrups having a similar foot-support principle and designed to be connected detachably to a stirrup leather, by means of an attachment device, are known.

In particular, document EP 0199628 B1 describes a safety stirrup in which the attachment device comprises an elastic clamp in which the two jaws clamp the top portion of the stirrup head and cooperate with a cam provided at said upper end, the shape of which being such that same is able to begin separating the two jaws in the event of rotation of said cam about itself, until the stirrup is released.

In document DE 88 07 927 U1, a stirrup is also detachably attached to a buckle using an attachment device that includes a spring that presses a part against a shaft of the stirrup, in order to hold the lugs of the stirrup in the corresponding grooves of the buckle. In the event of a fall, torque is generated against the stiffness of the spring, causing the lugs to come out of the grooves and disengaging the stirrup from the buckle.

All of the safety stirrups known to date have specific drawbacks.

Thus, single-branch stirrup systems and articulated-tread stirrup systems may fail to work under certain circumstances. In the event of a fall, the tip of the foot may butt against the top of the stirrup.

The safety stirrup described in document EP 0199628 B1 mentioned above has the drawback of sometimes disengaging from the buckle during normal use, simply under the weight of the rider bearing on the stirrups.

The stirrup in document DE 8807927 U1 is quickly detached once a small angle is formed between the stirrup and the buckle. This results in untimely detachment, in particular when landing after jumps.

### OBJECTS AND SUMMARY

The invention is intended to overcome the drawbacks of safety stirrups previously described.

To do so, the present invention relates to a safety stirrup for horse riding comprising a buckle designed to be attached to a stirrup leather, a stirrup having an overall arch shape in which the rider inserts a foot in an insertion direction substantially perpendicular to the plane containing the arch, with a tread on the lower portion onto which a rider can place his foot, and at least one lateral branch linking said tread to a head of the stirrup, and an attachment device for attaching the head of the stirrup to the buckle that is designed to enable the stirrup to detach completely from the buckle in the event of a fall, characterized in that the attachment device includes:
a mechanism for clipping the stirrup to the buckle including at least one elastic element designed to cooperate with at least one relief provided on a corresponding surface to prevent the stirrup from unclipping from the buckle, and
a lower end of the buckle and the head of the stirrup cooperating via sliding surfaces with curved profile to enable, before unclipping and/or complete detachment of the stirrup and of the buckle, a relative rotation of the stirrup and of the buckle in said insertion direction of a foot of the rider in the stirrup.

Thus, in the event of a rider falling, the stirrup can be uncoupled from the buckle in two stages: a first stage in which the stirrup is unclipped, and a second stage in which the stirrup is completely detached from the buckle. The rider nonetheless has greater freedom under normal usage conditions, since he can impart relative rotational movements between the stirrup and the buckle without necessarily causing full detachment, or even unclipping. The term “normal conditions” means horse-riding conditions not involving falls.

According to one possible embodiment, said at least one relief of the clip mechanism is a notch formed on the corresponding surface, the notch having an end stop designed to cooperate with said elastic element to prevent the stirrup from unclipping from the buckle under normal conditions, said elastic element being designed to move past the stop to enable unclipping.

According to one possible embodiment, the notch extends parallel to the curved profile over a given length to enable the relative rotation of the stirrup and of the buckle in said insertion direction of a foot of the rider into the stirrup before the elastic element moves past the end stop to enable unclipping. In this embodiment, the relative rotation of the stirrup and of the buckle is therefore made possible before unclipping occurs.

In this case, the notch may also include an intermediate stop.

The notch may also have a variable depth, and more specifically a depth that lessens closer to the end stop.

According to another possible embodiment, the length of the notch is adjusted to fit the size of a free end of the elastic element, such that the relative rotation of the stirrup and of the buckle in said insertion direction of a foot of the rider in the stirrup is only possible after unclipping and before complete detachment of the stirrup and of the buckle. In this embodiment, unclipping is therefore nearly immediate if the rider imparts a rotational movement, but will not necessarily result in complete detachment of the stirrup and of the buckle due to the angular freedom provided by the curved sliding surfaces.

According to other possible features of the present invention, taken individually or in combination:
The sliding surfaces with curved profile may be defined by contact surfaces between at least one lateral extension and at least one flange having a surface that forms a shoulder against which a corresponding surface of said at least one lateral extension bears,
Said at least one lateral extension may be carried by the lower end of the buckle, said at least one flange then being inside the head of the stirrup and extending parallel to the plane containing the arch,
As a variant, said at least one lateral extension is carried by the head of the stirrup and extends perpendicular to the plane containing the arch, said at least one flange then being in the lower end of the buckle,
The elastic element may be seated primarily in a recess provided in the head of the stirrup. In this case, said corresponding surface including at least one relief may be either a lower surface of the lower end of the buckle, or a lower surface of a part attached removably beneath the lower end of the buckle,
As a variant, the elastic element is seated primarily in a recess provided in the buckle. In this case, said corresponding surface including at least one relief is either a surface of the head of the stirrup or an upper surface of a part attached removably to the head of the stirrup,
Said elastic element may include a spring,
The clip mechanism may also include an element intended to facilitate sliding between a free end of the elastic element and said at least one relief,
Said elastic element may also be an elastomer,
The attachment device may also include a front stop between the buckle and the head of the stirrup.

### BRIEF DESCRIPTION OF DRAWINGS

Other features and advantages of the present invention are set out in greater detail in the description below of several non-limiting embodiments of the invention, provided with reference to the attached figures, in which:

FIG. 1 is an exploded perspective view of the different elements comprising a safety stirrup for horse-riding according to a first possible embodiment of the invention,

FIG. 2 is a perspective view of the assembled safety stirrup in FIG. 1,

FIG. 3 is a partial cross section, taken in the plane of the arch forming the stirrup, of the upper portion of the assembled safety stirrup in FIG. 2,

FIGS. 4 and 5 are partial perspective views, respectively semi-exploded and assembled, of the upper portion of the safety stirrup in FIGS. 1 to 3,

FIG. 6 is another semi-exploded partial perspective view of the upper portion of the safety stirrup in FIGS. 1 to 5,

FIGS. 7a to 7d are cross sections, taken in a plane perpendicular to the plane of the stirrup, showing the fall sequence of a rider whose foot is in the safety stirrup in FIGS. 1 to 6,

FIG. 8 is a partial cross section, taken in a plane perpendicular to the plane of the stirrup, showing a variant embodiment with a notch of variable depth,

FIG. 9 is a partial cross section, taken in a plane perpendicular to the plane of the stirrup, showing another variant embodiment with a two-indent notch,

FIG. 10 is a partial cross section, taken in a plane perpendicular to the plane of the stirrup, showing another variant embodiment with a close-fitting notch,

FIG. 11 is a partial cross section, taken in the plane of the arch forming the stirrup, of the upper portion of a assembled safety stirrup according to another embodiment, with an off-centre clip mechanism,

FIG. 12 is a partial cross section, taken along the plane of the arch forming the stirrup, of the upper portion of an assembled safety stirrup according to another embodiment,

FIG. 13 is a semi-exploded partial perspective view of the upper portion of an assembled safety stirrup according to another embodiment, in which the position of the flanges and of the lateral extensions has been inverted,

FIG. 14 is a partial cross section, taken in a plane perpendicular to the plane of the stirrup, showing another embodiment in which the elastic element of the clip mechanism is seated in the buckle,

FIG. 15 is a partial cross section, taken in a plane perpendicular to the plane of the stirrup, showing another embodiment for the elastic element,

FIG. 16 is a semi-assembled partial perspective view of a variant embodiment of the stirrup in FIGS. 1 to 6.

### DETAILED DESCRIPTION

Identical or equivalent elements in the figures have the same reference signs.

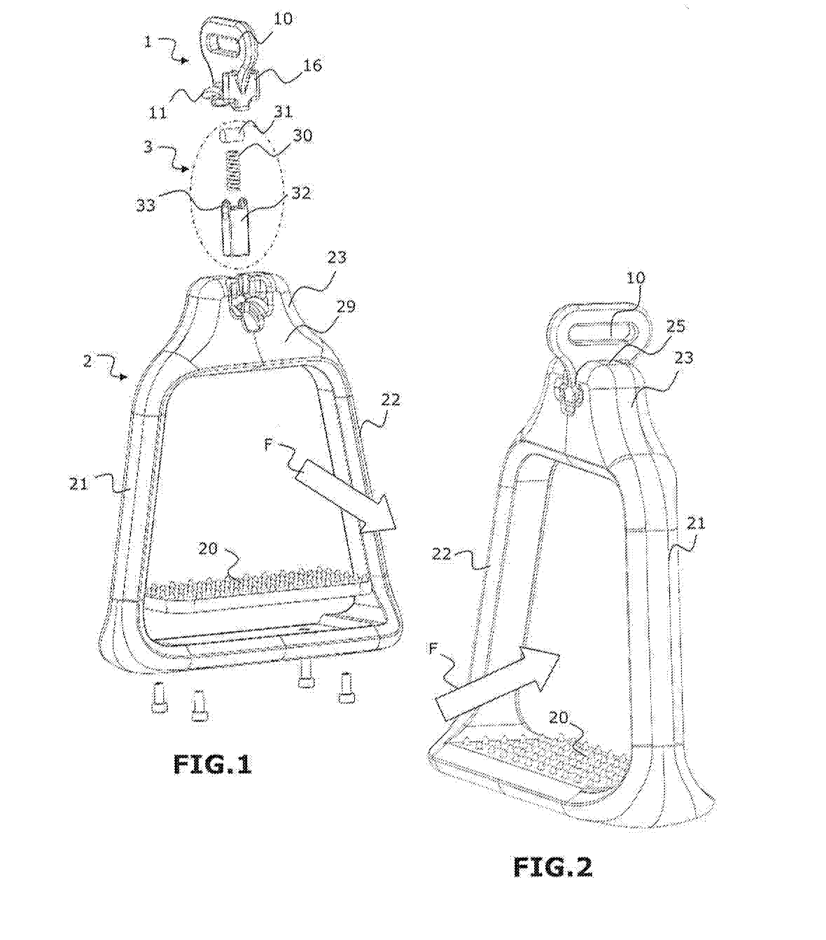

A safety stirrup for horse-riding according to a first possible embodiment is described below with reference to FIGS. 1 to 7a-7d. The safety stirrup for horse riding essentially comprises three parts, specifically a buckle 1, a stirrup 2 and a clip mechanism 3 interposed between the buckle 1 and the stirrup 2.

This clip mechanism 3 forms, with other parts positioned firstly on the lower end of the buckle 1 and secondly on the upper portion of the stirrup 2, a device for attaching the stirrup 2 to the buckle 1 that is designed to permit unclipping or complete detachment of the stirrup 2 from the buckle 1 in the event of a rider fall, as explained below.

The stirrup 2 has an overall arch shape in which a rider can insert a foot in an insertion direction that is substantially perpendicular to the plane containing the arch. The insertion direction of the foot is shown by the arrow F, in particular in FIGS. 1 and 2. The stirrup 2 conventionally includes a tread 20 in the lower portion onto which a rider can place his foot, and two lateral branches 21, 22 linking the tread 20 to a head 23 stirrup 2. The stirrup 2 may also have a single lateral branch between the tread 20 and the head 23. As shown in some of the figures, the tread 20 may advantageously include projections or any other means designed to enhance adherence and potentially to provide shock absorption.

The buckle 1 has an opening 10 on the upper end of same through which a stirrup leather (not shown) may be attached.

As specified previously, the attachment device is formed by elements carried firstly on the buckle 1 and secondly on the stirrup, as well as on the clip mechanism 3 interposed between the two.

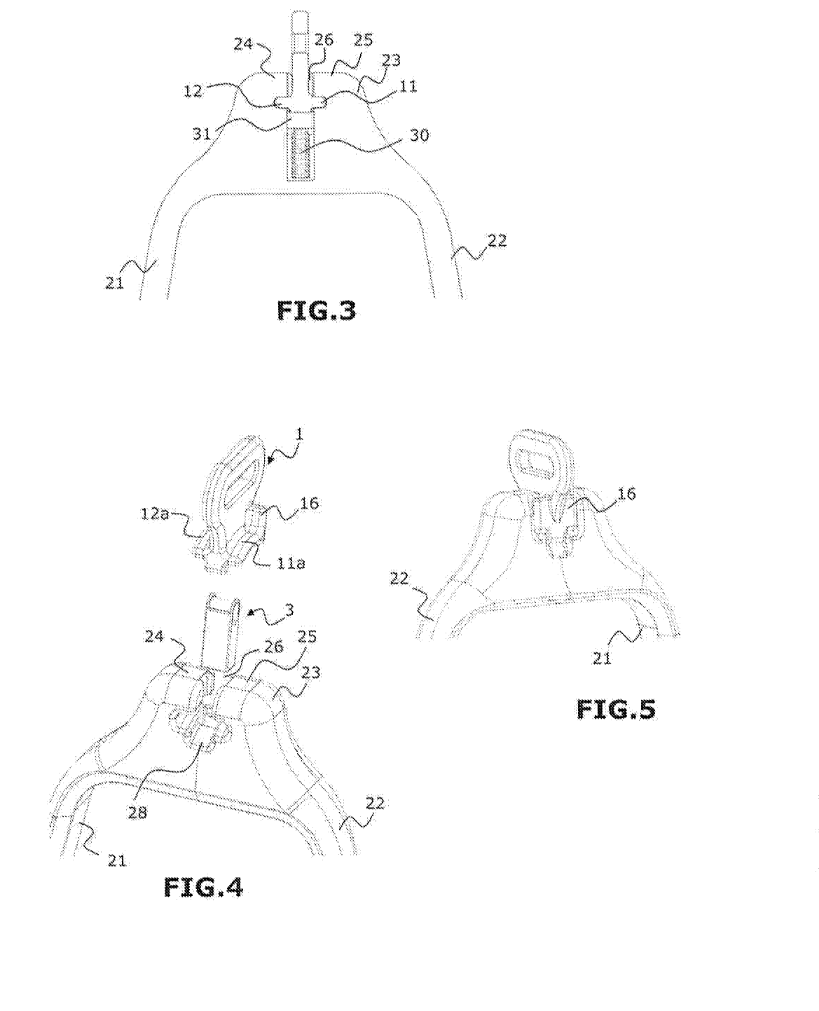

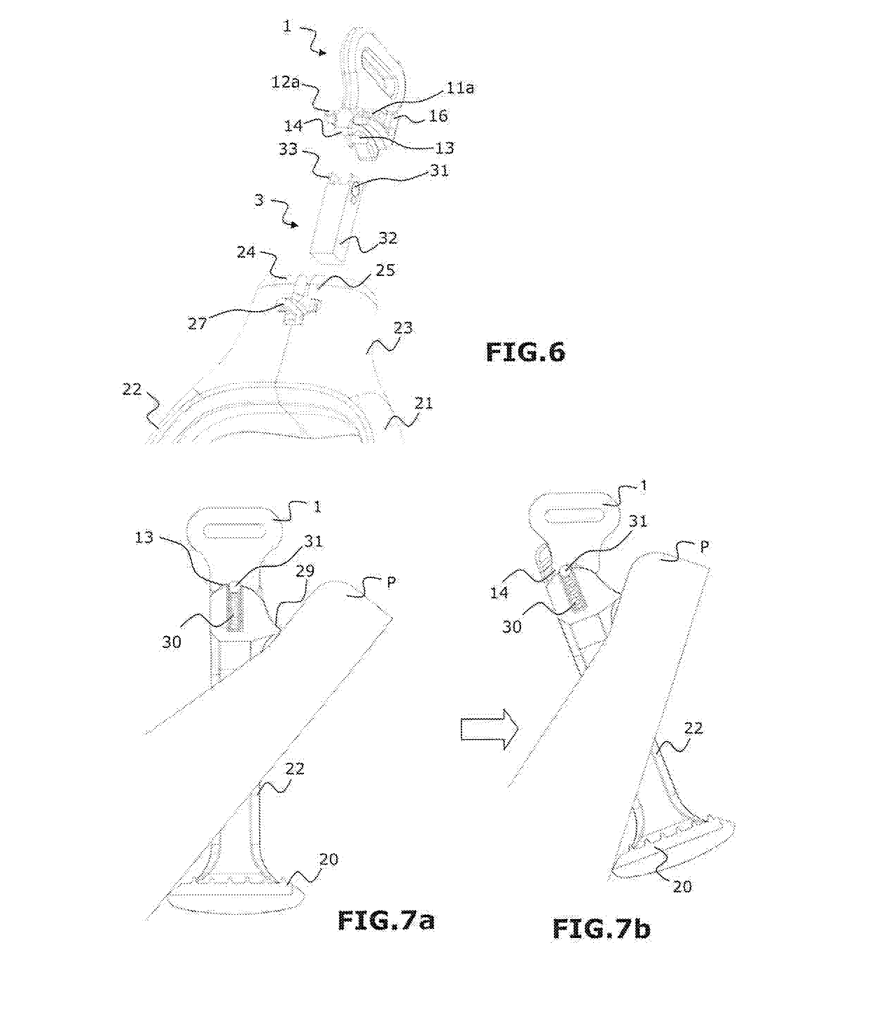

More specifically, the buckle 1 has two lateral extensions 11 and 12 on the lower end of same (particularly visible in FIGS. 1, 3, 4) that are designed to cooperate with two flanges 24, 25 fitted to the head 23 of the stirrup 2. As shown in particular in FIGS. 3 and 4, the two flanges 24, 25 extend opposite one another and parallel to the plane containing the arch, said flanges forming a passage 26 intended to receive the lower end of the buckle 1. More specifically, the lower surfaces 27 of the two flanges 24, 25 (only one of which is visible in FIG. 6) form two shoulders against which the upper surfaces of the two lateral extensions 11 and 12 bear respectively (see in particular FIGS. 3 and 6).

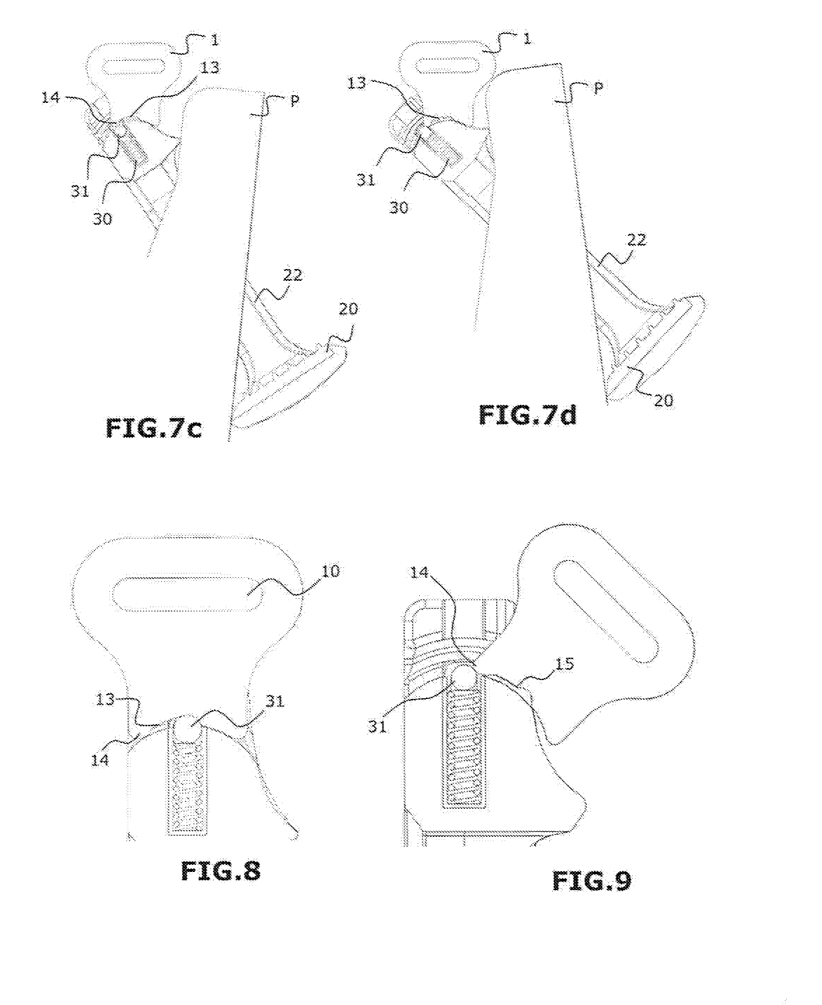

The mechanism 3 for clipping the stirrup 2 to the buckle 1 extends between the two flanges 24 and 25. The clip mechanism includes at least one elastic element, in this case a spring 30 extending along the longitudinal axis of the stirrup 2, having a free end that is received, in a clipped position, in a corresponding notch 13 formed in a lower surface of the lower end of the buckle 1, linking the two lateral extensions 11, 12 (see in particular FIGS. 7a, 7c and 7d). The notch 13 has an end stop 14 that is designed to cooperate with the free end of the elastic element 30 to prevent the stirrup 2 from unclipping from the buckle 1. Conversely, the elastic element 30 may under certain circumstances move past the end stop 14 to enable unclipping. A roller 31 or any other element designed to facilitate sliding between the free end of the elastic element 30 and the end stop 14 is preferably provided in the clip mechanism 3.

In the embodiment shown, the elastic element 30 is seated primarily in a central recess 28 provided in the head 23 of the stirrup 2, beneath the passage 26 formed by the two flanges 24, 25 (see FIG. 4). To facilitate the preservation and assembly of the parts, the elastic element 30 is advantageously seated inside a substantially parallelepipedic cartridge 32 (FIGS. 1 and 6), which may be inserted into the central recess 28 of matching shape.

The cartridge 32 advantageously has two lugs 33 (FIGS. 1 and 6) that are used to retain the roller 31 to prevent same from touching the bottom of the corresponding notch 13 when in the clipped position, and also to prevent same from being ejected following unclipping. FIGS. 4 and 6 in particular show how the roller 31 is held in the cartridge 32 of the clip mechanism 3.

In normal use, the stirrup 2 is clicked to the buckle 1 by the action of the spring 30, which is compressed and pushes the roller 31 into the notch 13 of the buckle.

Furthermore and according to an important feature of the invention, the lower surfaces 27 of the two flanges 24, 25 provided in the head 23 of the stirrup on one hand, and the upper surfaces 11a, 12a of the two lateral extensions 11, 12 provided on the lower end of the buckle 1 on the other hand have a curved profile and together form sliding surfaces to enable a relative rotation of the stirrup 2 and of the buckle 1 in said insertion direction of a foot of the rider into the stirrup.

Furthermore, in this embodiment and as shown particularly in FIGS. 7a to 7d, the notch 13 is wide in that same extends parallel to the curved profile over a given length to enable the relative rotation of the stirrup 2 and of the buckle 1 in said insertion direction of a foot of the rider into the stirrup before the elastic element 30 moves past the end stop 14 to enable unclipping.

The sliding surfaces 11a, 12a and 27 combined with a wide notch provide the stirrup 2 with angular freedom in relation to the buckle 1 before the elastic element 30 moves past the end stop 14 to enable unclipping. After unclipping, the portions of the sliding surfaces 11a, 12a and 27 that are still in contact enable a relative rotation that is sufficient to result in complete detachment if the situation requires (in the event of a fall).

FIGS. 7a to 7d more specifically show a sequence of the relative positions of the buckle 1 and of the stirrup 2 occurring in the event of a rider falling towards the rear of the horse. In these figures, the safety stirrup for horse-riding is shown as a cross-section taken in a plane perpendicular to the plane of the stirrup, and reference sign P is used to identify a foot of the rider inserted in the stirrup in the insertion direction shown by the arrow F.

At the beginning of the fall (FIG. 7a), the foot P is caught at the top of the stirrup. A shape 29 (also shown in FIG. 1) is preferably provided at the top of the stirrup to stop the front of the shoe. This shape 29 prevents the foot from hindering the release of the buckle in the event of a fall.

Torque is then generated, turning the stirrup 2 in relation to the buckle 1 as a result of the curved shape or profile of the sliding surfaces The stirrup 2 nonetheless remains clipped to the buckle 1 until the roller 31 reaches the end stop 14 (FIG. 7b).

As the rider continues falling backwards, the torque is sufficiently high for the end stop 14 to compress the spring 30 and force the roller 31 to enter the seat of the cartridge (FIG. 7c). After unclipping, the stirrup can be completely detached from the buckle 1.

In the embodiment described above, it is clear that angular freedom is essentially provided before the stirrup 2 is unclipped from the buckle 1. Thus, under normal conditions nonetheless involving jumps, the stirrup can still move in relation to the buckle without unclipping (and therefore without complete detachment). Unclipping and then detachment only occur in the event of a fall.

The notch 13, as shown in FIGS. 7a to 7d, has a fixed depth. As a variant, as shown in FIG. 8, the notch 13 may have a variable depth, and more specifically said depth may lessen as the roller 31 approaches the end stop 14. This solution advantageously enables the stirrup to be centred while enabling resisting angular freedom. When the constraint is removed, the stirrup 2 automatically centres itself.

In another variant embodiment shown in FIG. 9, a two-indent notch with an appropriately placed intermediate stop may be provided. This provides two successive notches, the dimensions of which can be varied advantageously. For example, a first portion of the notch, before the intermediate stop 15, may have substantially the same diameter as the roller 31, and a second portion of the notch, between the intermediate stop 15 and the end stop 14, may be shallower. In this case, after a first unclipping (moving past the intermediate stop 14), the roller 31 is in the second, shallower portion of the notch, which enables restricted angular freedom (the spring 30 is slightly compressed and the stirrup 2 turns less freely). This solution enables the stirrup to be centred while enabling some angular freedom in the event of a bad landing not involving a fall.

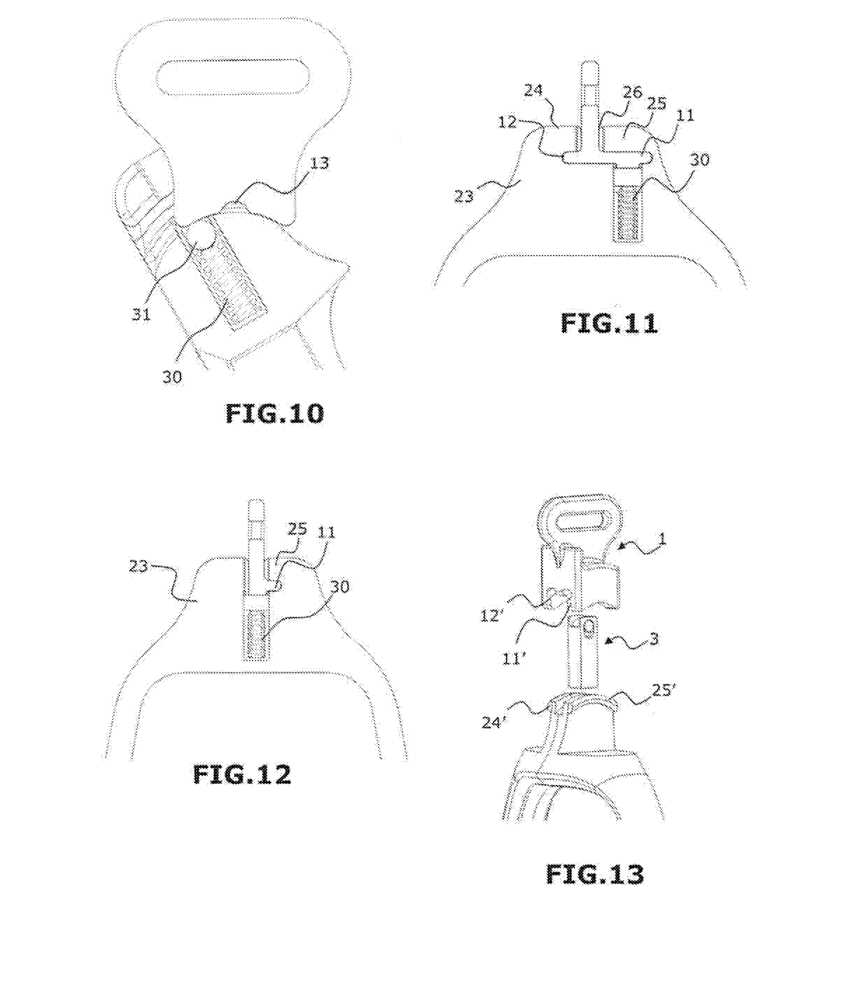

In another variant embodiment shown in FIG. 10, the length of the notch 13 is adjusted to the size of the free end, in this case the roller 31, of the elastic element 30. In this case, since the roller 31 is already stopped in the clipped position, the spring 30 is immediately compressed by the slightest relative rotational movement between the buckle and the stirrup, in particular in the event of a fall, and the stirrup 2 is unclipped from the buckle 1. However, the stirrup 2 and the buckle 1 have not yet been detached, and are still connected to one another by the portions of the sliding surfaces that are still in contact. This unclipped position without complete detachment is shown in FIG. 10.

The attachment device also advantageously includes a front stop 16 between the buckle 1 and the head 23 of the stirrup, in this example carried by the buckle 1. The front stop 16 is intended to prevent the stirrup from turning forwards (in the event of a bad jump, bad landing, etc.).

Other embodiments of a safety stirrup for horse-riding according to the principles of the invention are described below with reference to FIGS. 11 to 16. In particular, only the notable differences from the stirrup described above are given.

Thus, FIG. 11 shows that the clip mechanism with the spring 30 thereof is not necessarily beneath the passage 26 created by the two opposing flanges 24 and 25, but may be offset horizontally. The lateral extensions 11, 12 and the seats formed by the flanges to receive these extensions are thus asymmetrical, unlike as shown in FIG. 3.

It is also not necessary for the curved sliding surfaces to be defined by the contact surfaces between two lateral extensions cooperating with two flanges. FIG. 12 thus shows how a single flange 25 may be provided in the head 23 of the stirrup, to cooperate with a lateral extension 11 on the buckle.

The flange/lateral extension coupling may also be inverted. Thus, FIG. 13 shows how two flanges 11′ and 12′ can be provided on the lower end of the buckle 1, and how the lateral extensions 24′ and 25′ can be provided on the head 23 of the stirrup. Unlike the example shown in FIG. 3, in this case the upper surfaces of the two flanges 11′, 12′ form two shoulders against which the lower surfaces of the two lateral extensions 24′ and 25′ bear respectively.

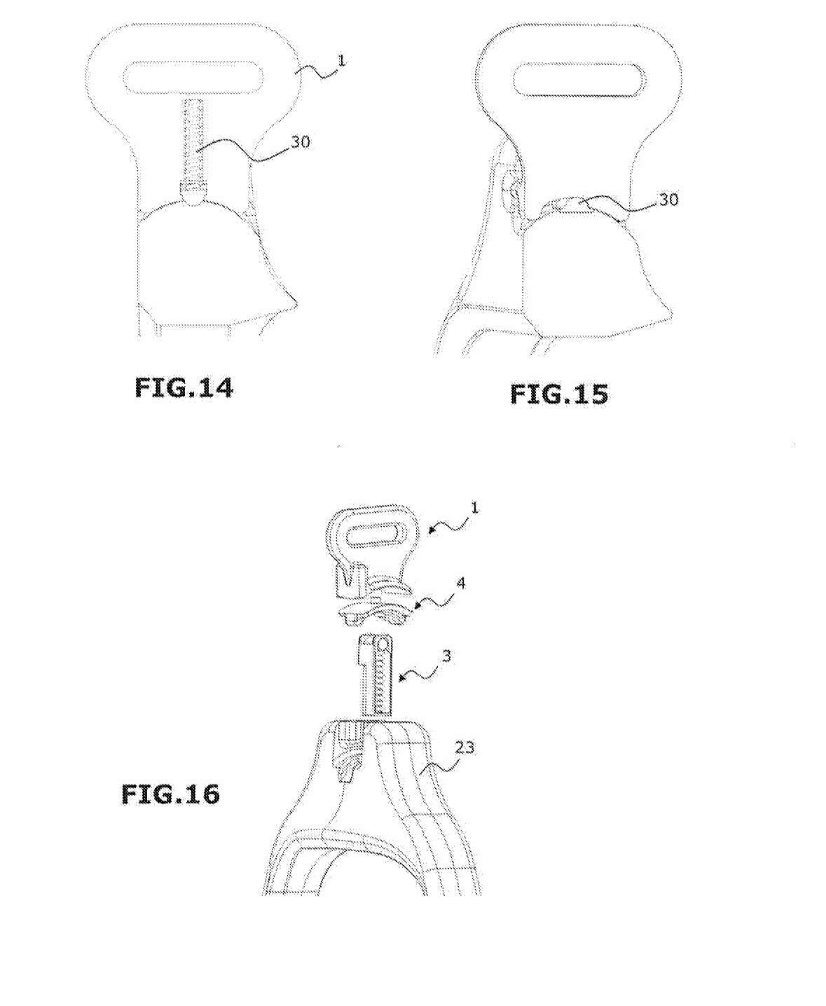

In the embodiments described so far, the elastic element 30 of the clip mechanism is seated primarily in a recess 28 provided in the head 23 of the stirrup. However, entirely equivalently and as shown in FIG. 14, the position of the parts of the clip mechanism may be inverted by seating the elastic element 30 of the clip mechanism primarily in a recess provided in the buckle 1. The corresponding surface with at least one relief (for example the notch and the end stop of same described above) is then carried by the head of the stirrup.

The elastic element 30 may also be an elastomer such as the one shown in FIG. 15. The elastic element may be a ball. In this case, the relief cooperating with the elastic element may be a slot or simply a hole.

A particularly interesting embodiment is shown in FIG. 16. In this embodiment, a part 4 designed to be attached removably beneath the lower end of the buckle 1 is provided. A lower surface of this part 4 includes the notch into which the end of the spring 30 is seated, instead of a lower surface of the lower end of the buckle 1 directly. The part 4 can therefore be changed easily in the event of premature wear. Another advantage is that a given rider can choose a part 4 with a different notch, thereby adjusting the angular freedom provided. If the elastic element 30 is primarily seated in the buckle, the removable part can then be attached to the head of the stirrup, and includes the corresponding notch on the upper surface of same.

1. Safety stirrup for horse riding comprising:
a buckle designed to be attached to a stirrup leather,
a stirrup having an overall arch shape in which the rider inserts a foot in an insertion direction substantially perpendicular to the plane containing the arch, with a tread on the lower portion onto which a rider can place his foot, and at least one lateral branch linking said tread to a head of the stirrup, and an attachment device for attaching the head of the stirrup to the buckle that is designed to enable the stirrup to detach completely from the buckle in the event of a fall,
wherein the attachment device includes:
a mechanism for clipping the stirrup to the buckle including at least one elastic element designed to cooperate with at least one relief provided on a corresponding surface to prevent the stirrup from unclipping from the buckle, and
a lower end of the buckle and the head of the stirrup cooperating via sliding surfaces with curved profile to enable, before unclipping and/or complete detachment of the stirrup and of the buckle, a relative rotation of the stirrup and of the buckle in said insertion direction of a foot of the rider in the stirrup.

2. Safety stirrup for horse riding according to claim 1, wherein said at least one relief is a notch formed on said corresponding surface, the notch having an end stop designed to cooperate with said elastic element to prevent the stirrup from unclipping from the buckle under normal conditions, said elastic element being designed to move past the end stop to enable unclipping.

3. Safety stirrup for horse riding according to claim 2, wherein the notch extends parallel to the curved profile over a given length to enable the relative rotation of the stirrup and of the buckle in said insertion direction of a foot of the rider into the stirrup before the elastic element moves past the end stop to enable unclipping.

4. Safety stirrup for horse riding according to claim 2, wherein the notch also has an intermediate stop.

5. Safety stirrup for horse riding according to claim 2, wherein the notch has a variable depth, which lessens closer to the end stop.

6. Safety stirrup for horse riding according to claim 2, wherein the length of the notch is adjusted to fit the size of a free end of the elastic element, such that the relative rotation of the stirrup and of the buckle in said insertion direction of a foot of the rider in the stirrup is only possible after unclipping and before complete detachment of the stirrup and of the buckle.

7. Safety stirrup for horse riding according to claim 1, wherein the sliding surfaces with curved profile are defined by contact surfaces between at least one lateral extension, at least one flange having a surface that forms a shoulder against which a corresponding surface of said at least one lateral extension bears.

8. Safety stirrup for horse riding according to claim 7, wherein said at least one lateral extension is carried by the lower end of the buckle while said at least one flange is on the head of the stirrup and extends parallel to the plane containing the arch.

9. Safety stirrup for horse riding according to claim 7, wherein said at least one lateral extension is carried by the head of the stirrup and extends perpendicular to the plane containing the arch, while said at least one flange is in the lower end of the buckle.

10. Safety stirrup for horse riding according to claim 1, wherein said elastic element is seated primarily in a recess provided in the head of the stirrup.

11. Safety stirrup for horse riding according to claim 10, wherein said corresponding surface including at least one relief is a lower surface of the lower end of the buckle.

12. Safety stirrup for horse riding according to claim 11, wherein said corresponding surface including at least one relief is a lower surface of a part attached removably beneath the lower end of the buckle.

13. Safety stirrup for horse riding according to claim 1, wherein said elastic element is seated primarily in a recess provided in the buckle.

14. Safety stirrup for horse riding according to claim 13, wherein said corresponding surface including at least one relief is a surface of the head of the stirrup.

15. Safety stirrup for horse riding according to claim 13, wherein said corresponding surface including at least one relief is an upper surface of a part attached removably to the head of the stirrup.

16. Safety stirrup for horse riding according to claim 1, wherein said elastic element includes a spring.

17. Safety stirrup for horse riding according to claim 16, wherein the clip mechanism also includes an element intended to facilitate sliding between a free end of the elastic element and said at least one relief.

18. Safety stirrup for horse riding according to claim 1, wherein said elastic element is an elastomer.

19. Safety stirrup for horse riding according to claim 1, wherein the attachment device also includes a front stop between the buckle and the head of the stirrup.
